(19) United States
(12) Patent Application Publication
(10) Pub. No.: US 2018/0275414 A1
(43) Pub. Date: Sep. 27, 2018

(54) DISPLAY DEVICE AND DISPLAY METHOD

(71) Applicant: Panasonic Intellectual Property Management Co., Ltd., Osaka (JP)

(72) Inventors: AKIRA TANAKA, Osaka (JP); NOBUYUKI NAKANO, Osaka (JP); MASANAGA TSUJI, Osaka (JP)

(21) Appl. No.: 15/901,897

(22) Filed: Feb. 22, 2018

(30) Foreign Application Priority Data
Mar. 23, 2017 (JP) 2017-057761

(51) Int. Cl. G02B 27/01; G02B 27/22

(52) U.S. Cl. CPC G02B 27/0179; G02B 27/2292; G02B 2027/014; G02B 2027/0187; G02B 2027/0138; G02B 27/0101

(57) ABSTRACT

A display device includes a display unit, an imaging optical element, a detector, and an adjustor. The display unit includes a display surface for displaying an image. The imaging optical element includes an element plane. The imaging optical element causes the image displayed on the display surface to be imaged as an aerial image in an aerial display region positioned plane-symmetrically to the display surface with respect to the element plane. The detector detects a position of a head of a user existing in front of the display region. The adjustor adjusts a position of the image with respect to the imaging optical element based on a detection result obtained by the detector.

### BACKGROUND

### 1. Technical Field

The present disclosure relates to a display device and a display method that display an aerial image in an aerial display region.

### 2. Description of the Related Art

A display device that displays an aerial image in an aerial display region is known (see, for example, International Publication No. 2009/131128 and Japanese Patent Unexamined Publication No. 2013-33344). This type of display device uses a display panel and an imaging optical panel. An image displayed on the display panel is imaged as an aerial image in an aerial display region that is positioned plane-symmetrically to the display panel with respect to the imaging optical panel. This enables the user to visually observe the aerial image floating in air.

### SUMMARY

The present disclosure provides a display device and a display method that enable the user to visually observe an aerial image properly even when the user changes a posture thereof.

A display device according to an aspect of the present disclosure includes a display unit, an imaging optical element, a detector, and an adjustor. The display unit includes a display surface for displaying an image. The imaging optical element includes an element plane. The imaging optical element causes the image displayed on the display surface to be imaged as an aerial image in an aerial display region positioned plane-symmetrically to the display surface with respect to the element plane. The detector detects a position of a head of a user existing in front of the display region. The adjustor adjusts a position of the image with respect to the imaging optical element based on a detection result obtained by the detector.

In a display method according an embodiment of the present disclosure, an image is displayed on a display surface of a display unit. The image displayed on the display surface is caused to be imaged as an aerial image in an aerial display region positioned plane-symmetrically to the display surface with respect to an element plane of an imaging optical element. Meanwhile, a position of a head of a user existing in front of the display region is detected. Then, a position of the image with respect to the imaging optical element is adjusted based on the detected position of the head of the user.

The present disclosure enables the user to visually observe an aerial image properly even when the user changes the posture thereof.

### BRIEF DESCRIPTION OF DRAWINGS

FIG. 1 is a view illustrating a schematic configuration of a display device according to a first exemplary embodiment of the present disclosure.

FIG. 2 is a perspective view selectively illustrating a display unit and an imaging optical element of the display device shown in FIG. 1.

FIG. 3 is a block diagram illustrating the functional configuration of a controller of the display device shown in FIG. 1.

FIG. 4 is a view for illustrating functions of a head detector and a fingertip detector shown in FIG. 3.

FIG. 5 is a view for illustrating functions of an operation screen image generator and an operation screen image renderer shown in FIG. 3.

FIG. 6 is a flowchart illustrating operations of the display device shown in FIG. 3.

FIG. 7 is a view for illustrating an example of a detection range of the position of the user's head to be detected by the head detector shown in FIG. 3.

FIG. 8 is a view illustrating an example of a table stored in a memory storage shown in FIG. 3.

FIG. 9 is a view illustrating examples of an operation screen image rendered by the operation screen image renderer shown in FIG. 3.

FIG. 10A is a perspective view illustrating a situation in which the posture of the user changes with respect to the display device shown in FIG. 1.

FIG. 10B is a perspective view illustrating a situation in which a display position of an aerial image in a display region is adjusted with the display device shown in FIG. 1.

FIG. 11 is a block diagram illustrating the functional configuration of a controller of a display device according to a second exemplary embodiment of the present disclosure.

FIG. 12 is a perspective view illustrating a configuration of the display device shown in FIG. 11.

### DETAILED DESCRIPTION OF PREFERRED EMBODIMENTS

Problems with a conventional display device will be described briefly prior to describing exemplary embodiments of the present disclosure. The conventional display device as described above may cause the user to be unable to visually observe an aerial image properly. For example, when the user changes his/her posture, the user may see an image in which part of the aerial image is lost.

Hereafter, exemplary embodiments of the present disclosure will be described in detail with reference to the drawings.

Note that all the exemplary embodiments described hereinbelow illustrate generic or specific examples. The numerical values, shapes, materials, structural elements, arrangements and connections of the structural elements, steps, order of the steps, etc. shown in the following exemplary embodiments are merely examples, and therefore do not limit the scope of the present disclosure. In addition, among the constituent elements in the following exemplary embodiments, those not recited in any one of the independent claims which indicate the broadest inventive concepts are described as optional elements.

### First Exemplary Embodiment

### 1-1. Schematic Configuration of Display Device

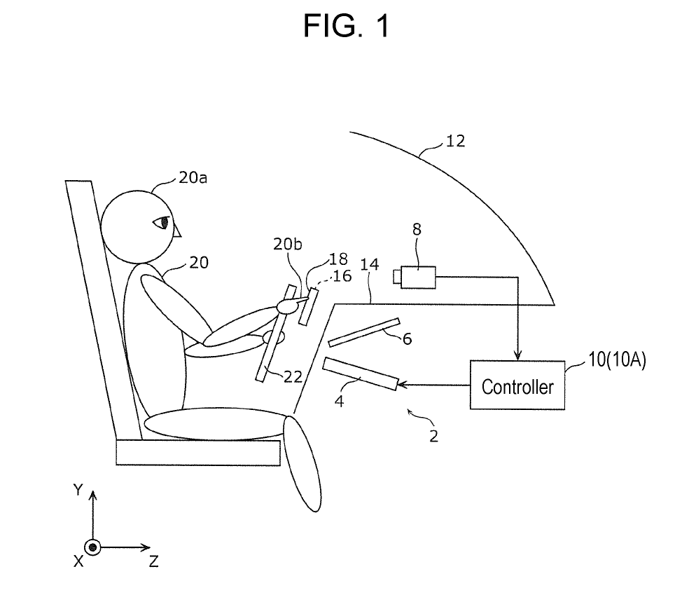

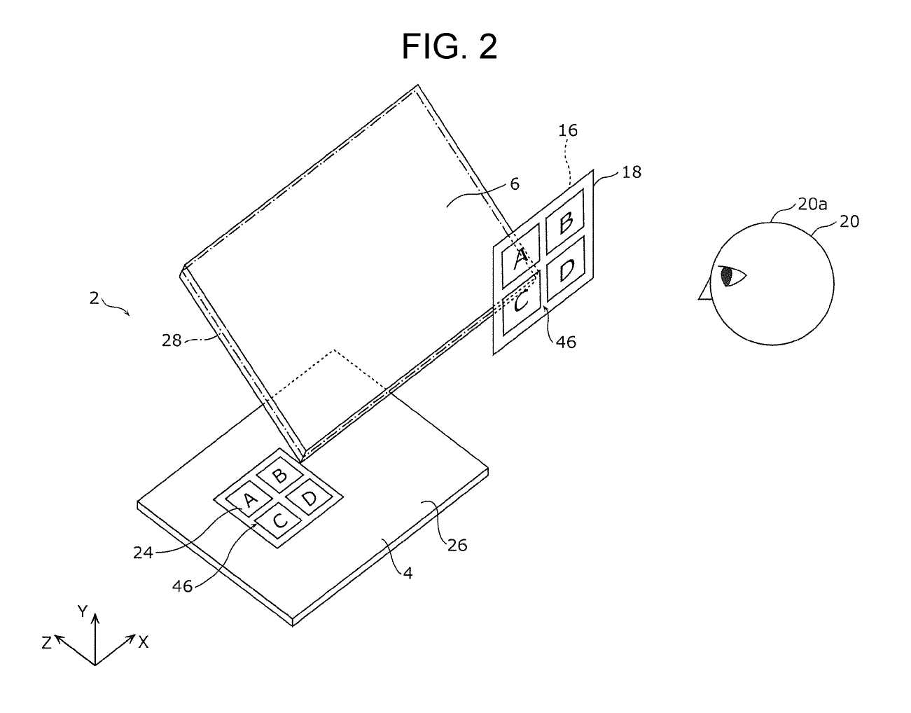

First, a schematic configuration of display device 2 according to a first exemplary embodiment will be described with reference to FIGS. 1 and 2. FIG. 1 is a view illustrating the schematic configuration of display device 2 according to the first exemplary embodiment. FIG. 2 is a perspective view selectively illustrating display unit 4 and imaging optical element 6 of display device 2.

As illustrated in FIG. 1, display device 2 includes display unit 4, imaging optical element 6, camera 8, and controller 10.

Display device 2 may be, for example, for vehicle applications. Display device 2 is disposed inside dashboard 14 of automobile 12. In addition, display device 2 has a function as an aerial display and a function as an aerial touchscreen. That is, display device 2 displays aerial image 18 in display region 16 in air (for example, in air near dashboard 14). In addition, display device 2 accepts a touch operation on aerial image 18 by user 20 (for example, a driver). Note that, in the drawings, the positive direction along the Z axis represents the direction of travel of automobile 12.

Aerial image 18 is, for example, operation screen image 46 (see FIG. 2) for operating on-board equipment mounted to automobile 12, such as a vehicle audio system, a vehicle air-conditioning system, and a vehicle navigation system. User 20 is able to operate on-board equipment of automobile 12 by touching aerial image 18 (operation screen image 46) floating in air with fingertip 20b, for example, while operating steering wheel 22 to drive automobile 12.

1-2. Display Unit and Imaging Optical Element

Next, display unit 4 and imaging optical element 6 will be described with reference to FIGS. 1 and 2.

Display unit 4 is, for example, a liquid crystal display panel. As illustrated in FIG. 2, display unit 4 includes display surface 26 for displaying image 24. Note that image 24 is smaller than display surface 26. In other words, image 24 is displayed only on a partial region of display surface 26. In the present exemplary embodiment, the position of display unit 4 is fixed with respect to imaging optical element 6.

Imaging optical element 6 is an optical device for causing image 24 that is displayed on display surface 26 of display unit 4 to be imaged as aerial image 18 in aerial display region 16. Element 6 is a so-called reflective-type plane-symmetric imaging element. Imaging optical element 6 is, for example, a flat-shaped plate formed of a resin material, and is disposed so as to be inclined at 45° with respect to display unit 4. Imaging optical element 6 includes element plane 28. As indicated by the dash-dotted line in FIG. 2, element plane 28 is a virtual plane through the thickness-wise center portion of imaging optical element 6, and is a plane parallel to a major surface (an incident surface or an exit surface) of imaging optical element 6.

A plurality of very small through-holes having a side of about 100 μm and a depth of about 100 μm are formed in element plane 28. The inner surfaces of the through-holes are formed by micromirrors (specular surfaces). The light entering the incident surface (the surface that faces display unit 4) of imaging optical element 6 is reflected two times, on adjacent two faces of each of the micromirrors of the plurality of through-holes, and thereafter exits from the exit surface (the surface that faces display region 16) of the imaging optical element 6.

The above-described configuration allows imaging optical element 6 to form aerial image 18, which is a virtual image of image 24, in aerial display region 16 that is positioned plane-symmetrically to display surface 26 with respect to element plane 28. Image 24 and aerial image 18 are in a 1:1 relationship with respect to imaging optical element 6 as the axis of symmetry. In other words, the distance from element plane 28 to image 24 on display surface 26 is equal to the distance from element plane 28 to aerial image 18 on display region 16, and also, the size of image 24 is equal to the size of aerial image 18.

1-3. Camera

Next, camera 8 will be described with reference to FIG. 1.

Camera 8 is, for example, a TOF (Time-of-Flight) camera, which is disposed above dashboard 14 of automobile 12.

Camera 8 captures IR (infrared radiation) images of head 20a and fingertip 20b of user 20 existing in front of display region 16 (i.e., toward the negative direction along the Z axis). The image data captured by camera 8 are transmitted to controller 10.

1-4. Controller

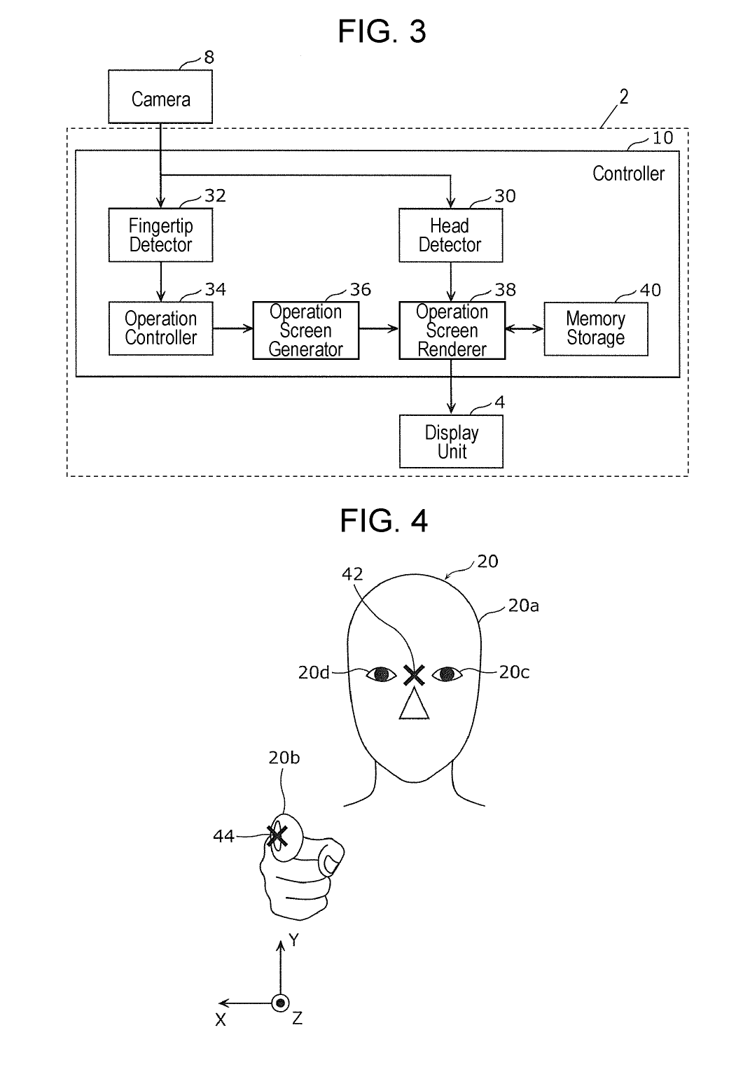

Next, controller 10 will be described with reference to FIGS. 3 to 5. FIG.

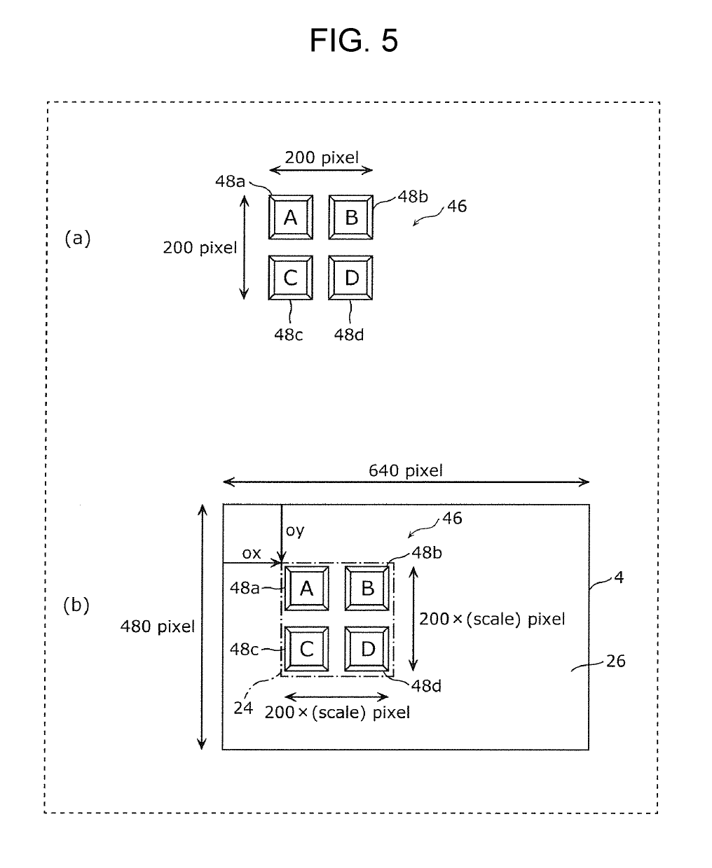

3 is a block diagram illustrating the functional configuration of controller 10. FIG. 4 is a view for illustrating the functions of head detector 30 and fingertip detector 32. FIG. 5 is a view for illustrating the functions of operation screen image generator (hereafter referred to simply as “generator”) 36 and operation screen image renderer (hereafter referred to simply as “renderer”) 38 in controller 10.

As illustrated in FIG. 3, controller 10 includes head detector 30, fingertip detector 32, operation controller 34, generator 36, renderer 38, and memory storage 40. Head detector 30 is an example of a detector, and renderer 38 is an example of an adjustor.

Head detector 30 detects, for example, a three-dimensional position of the midpoint between left eye 20c and right eye 20d of user 20 as position 42 of head 20a of user 20 shown in FIG. 4, based on image data from camera 8. Specifically, head detector 30 identifies a two-dimensional position of head 20a on an IR image by pattern recognition, and identifies a corresponding three-dimensional position of head 20a from a depth image.

Fingertip detector 32 detects, for example, a three-dimensional position of the fingertip 20b that has touched aerial image 18 (operation screen image 46) as position 44 of fingertip 20b of user 20 shown in FIG. 4, based on image data from camera 8. Specifically, fingertip detector 32 identifies a two-dimensional position of fingertip 20b on an IR image by pattern recognition, and identifies a corresponding three-dimensional position of fingertip 20b from a depth image.

Operation controller 34 determines whether or not aerial image 18 (operation screen image 46) has been touched by the user. Specifically, operation controller 34 determines that push button 48a has been touched by the user when the distance between position 44 of fingertip 20b detected by fingertip detector 32 and the three-dimensional position of, for example, push button 48a (see FIG. 5) on operation screen image 46 in aerial image 18 becomes equal to or less than a threshold value. In this case, operation controller 34 notifies generator 36 of a screen ID for changing operation screen image 46.

Generator 36 generates operation screen image 46 for operating on-board equipment of automobile 12, as shown in (a) of FIG. 5. Operation screen image 46 includes, for example, an image containing four push buttons 48a, 48b, 48c, and 48d arranged in a 2×2 matrix. One of a plurality of operations for the on-board equipment of automobile 12 is assigned to each of push buttons 48a, 48b, 48c, and 48d. For example, when the user touches push button 48a, a sound volume of the vehicle audio system of automobile 12 is increased as the operation assigned to push button 48a. Note that the size of operation screen image 46 is, for example, 200 pixels×200 pixels.

Memory storage 40 stores a table that associates position 42 of head 20a of user 20, the rendering starting position of operation screen image 46 in display surface 26, and the rendering scaling factor (scale) of operation screen image 46 in display surface 26 with each other. Position 42 is represented by coordinate (ex, ey, ez), and the rendering starting position is represented by coordinate (ox, oy).

Herein, rendering starting position (ox, oy) is a pixel position at which rendering of operation screen image 46 is started where the top-left vertex of display surface 26 of display unit 4 is defined as the origin (0 pixel, 0 pixel) in (b) of FIG. 5. That is, in (b) of FIG. 5, the position of the top-left vertex of operation screen image 46 is the rendering starting position. The rendering scaling factor is a rate by which the size of operation screen image 46 is enlarged or reduced.

As illustrated in (b) of FIG. 5, renderer 38 draws operation screen image 46 generated by generator 36 as image 24 on display surface 26 of display unit 4. Specifically, renderer 38 refers the table stored in memory storage 40 based on position 42 of head 20a detected by head detector 30. Thereby, renderer 38 determines rendering starting position (ox, oy) and rendering scaling factor (scale) of operation screen image 46 in display surface 26. Renderer 38 starts rendering of operation screen image 46 from the determined rendering starting position (ox, oy) and, also enlarges or reduces the size of operation screen image 46 by the determined rendering scaling factor. As a result, renderer 38 adjusts the display position and size of operation screen image 46 (image 24) in display surface 26. In other words, renderer 38 adjusts the position of image 24 with respect to imaging optical element 6. Note that the size of display surface 26 is, for example, 640 pixels×480 pixels.

1-5. Operations of Display Device

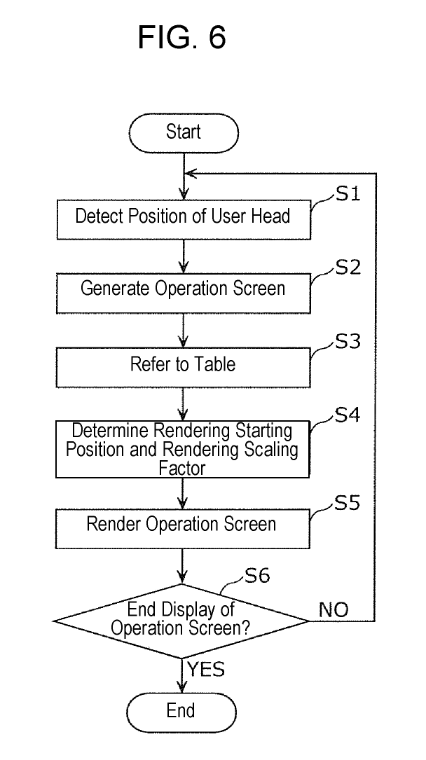

Next, operations (display method) of display device 2 will be described with reference to FIGS. 6 to 9.

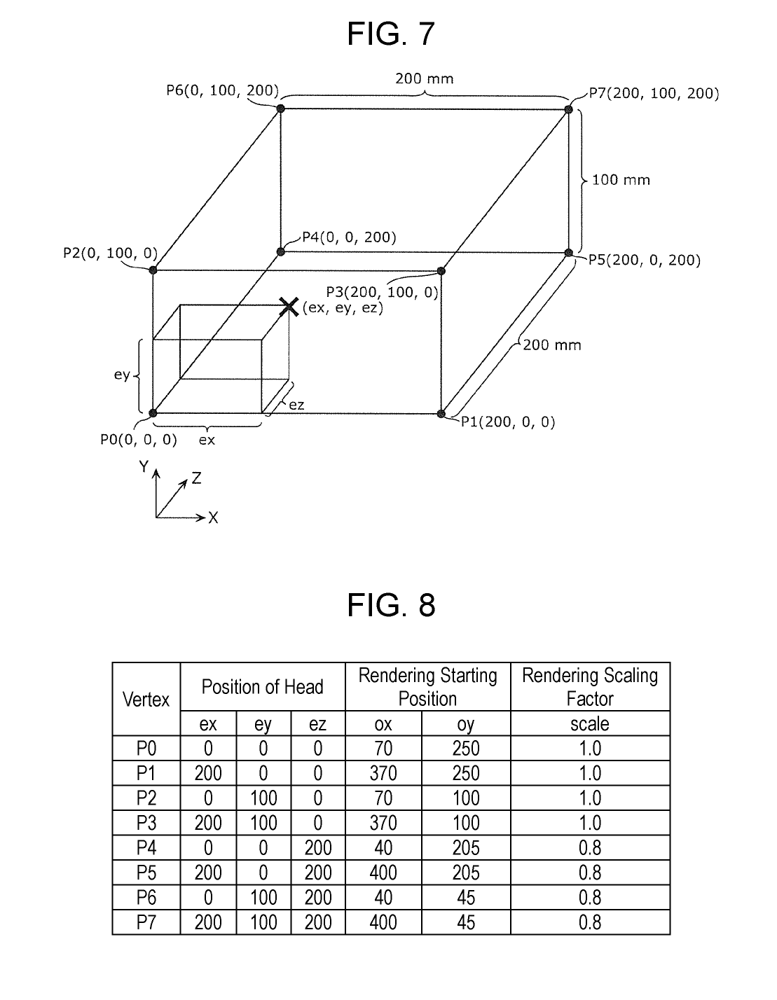

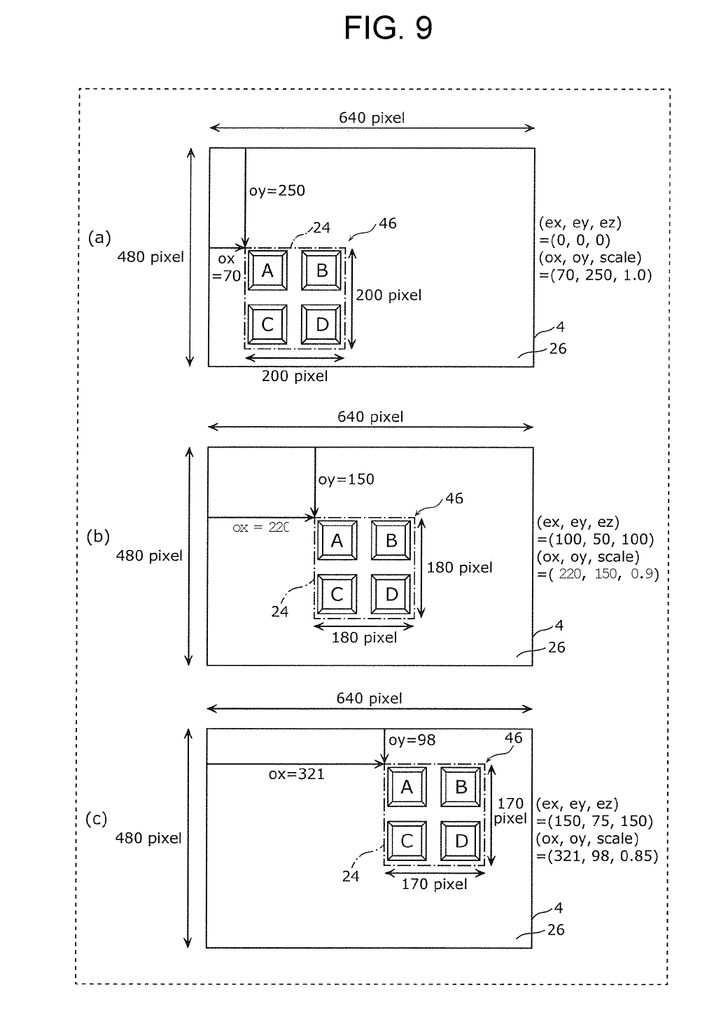

FIG. 6 is a flowchart illustrating operations of display device 2. FIG. 7 is a view for illustrating an example of detection range of position 42 of head 20a of user 20, which is detected by head detector 30. FIG. 8 is a view illustrating an example of a table stored in memory storage 40. FIG. 9 is a view illustrating examples of operation screen image 46 rendered by renderer 38.

As illustrated in FIG. 6, at first, head detector 30 detects position 42 of head 20a of user 20 based on image data from camera 8 (S1). At this time, in the example shown in FIG. 7, the detection range of position 42 of head 20a of user 20 that is detected by head detector 30 is the surfaces and the inside of a rectangular parallelepiped having a horizontal dimension (X-axis dimension) of 200 mm, a vertical dimension (Y-axis dimension) of 100 mm, and a depth dimension (Z-axis dimension) of 200 mm.

Note that the three-dimensional positions (x, y, z) of the eight vertices P0 to P7 of the detection range (rectangular parallelepiped) shown in FIG. 7 are defined as P0 (0, 0, 0), P1 (200, 0, 0), P2 (0, 100, 0), P3 (200, 100, 0), P4 (0, 0, 200), P5 (200, 0, 200), P6 (0, 100, 200), and P7 (200, 100, 200), respectively.

Thereafter, generator 36 generates operation screen image 46 (S2). Thereafter, renderer 38 refers the table stored in memory storage 40, based on position 42 of head 20a that has been detected by head detector 30 (S3). As illustrated in FIG. 8, in the table stored in memory storage 40, each of vertices P0 to P7 of the detection range is associated with position 42 (ex, ey, ez) of head 20a of user 20, rendering starting position (ox, oy) of operation screen image 46 in display surface 26, and rendering scaling factor (scale) of operation screen image 46 in display surface 26.

For example, in the first row (vertex P0) of the table, position 42 (0, 0, 0) of head 20a, rendering starting position (70, 250) of operation screen image 46, and rendering scaling factor 1.0 of operation screen image 46 are associated with each other. Also, in the fifth row (vertex P4) of the table, position 42 (0, 0, 200) of head 20a, rendering starting position (40, 205) of operation screen image 46, and rendering scaling factor 0.8 of operation screen image 46 are associated with each other.

Thereafter, renderer 38 determines the rendering starting position and the rendering scaling factor of operation screen image 46 in display surface 26, based on the referred result in the table (S4), and draws operation screen image 46 on display surface 26 of display unit 4 (S5).

At that time, if position 42 (ex, ey, ez) of head 20a detected by head detector 30 matches a three-dimensional position of any of vertices P0 to P7 of the detection range, renderer 38 determines the rendering starting position and the rendering scaling factor of operation screen image 46 directly from the table. For example, if position 42 (ex, ey, ez) of head 20a matches three-dimensional position (0, 0, 0) of vertex P0 of the detection range, renderer 38 employs rendering starting position (70, 250) and rendering scaling factor 1.0 of operation screen image 46, which correspond to vertex P0. Accordingly, as illustrated in (a) of FIG. 9, renderer 38 starts rendering of operation screen image 46 from rendering starting position (70, 250) and also adjusts the size of operation screen image 46 to 200(=200×1.0) pixels×200(=200×1.0) pixels.

It is also possible that position 42 of head 20a detected by head detector 30 may not match the three-dimensional position of any of vertices P0 to P7 of the detection range, but position 42 of head 20a is positioned inside the detection range. When this is the case, renderer 38 calculates the rendering starting position and the rendering scaling factor of operation screen image 46 from the three-dimensional positions of vertices P0 to P7 of the detection range by linear interpolation.

The following describes an example of the method of calculating rendering starting position ox by linear interpolation. First, renderer 38 linearly interpolates rendering start position ox along the X axis, as indicated by Eqs. 1 to 4. Note that ox1 to ox7 respectively represent the values of ox of rendering starting positions (ox, oy) corresponding to vertices P1 to P7. For example, in the example shown in FIG. 8, ox1 is 370, and ox7 is 400.

ox01=(200−ex)/200×ox0+ex/200×ox1 (Eq. 1)

ox23=(200−ex)/200×ox2+ex/200×ox3 (Eq. 2)

ox45=(200−ex)/200×ox4+ex/200×ox5 (Eq. 3)

ox67=(200−ex)/200×ox6+ex/200×ox7 (Eq. 4)

Next, renderer 38 linearly interpolates rendering start position ox along the Y axis, as indicated by Eqs. 5 and 6.

ox0123=(100−ey)/100×ox01+ey/100×ox23 (Eq. 5)

ox4567=(100−ey)/100×ox45+ey/100×ox67 (Eq. 6)

Next, renderer 38 linearly interpolates rendering start position ox along the Z axis, as indicated by Eq. 7.

ox01234567=(200−ez)/200×ox0123+ez/200×ox4567 (Eq. 7)

Renderer 38 determines ox01234567 obtained in the above-described manner to be rendering starting position ox. Renderer 38 also calculates rendering starting position oy and rendering scaling factor scale of operation screen image 46 by linear interpolation in a similar manner to the above.

For example, when position 42 (ex, ey, ez) of head 20a is positioned at the center (100, 50, 100) of the detection range, renderer 38 determines the rendering starting position to be at a coordinate (220, 150) and the rendering scaling factor to be 0.9 by the linear interpolation as described above. Accordingly, as illustrated in (b) of FIG. 9, renderer 38 starts rendering of operation screen image 46 from rendering starting position (230, 150) and also adjusts the size of operation screen image 46 to 180(=200×0.9) pixels×180(=200×0.9) pixels.

Also, for example, when position 42 (ex, ey, ez) of head 20a is positioned at position (150, 75, 150) that is near vertex P7 of the detection range, renderer 38 determines the rendering starting position to be at coordinate (321, 98) and the rendering scaling factor to be 0.85 by the linear interpolation as described above. Accordingly, as illustrated in (c) of FIG. 9, renderer 38 starts rendering of operation screen image 46 from rendering starting position (321, 98) and also adjusts the size of operation screen image 46 to 170(=200×0.85) pixels×170 (=200×0.85) pixels.

If the display of operation screen image 46 is to be performed continuously (NO in S6), the above-described steps S1 to S5 are executed again. If the display of operation screen image 46 is to be ended (YES in S6), the process is terminated.

1-6. Advantageous Effects

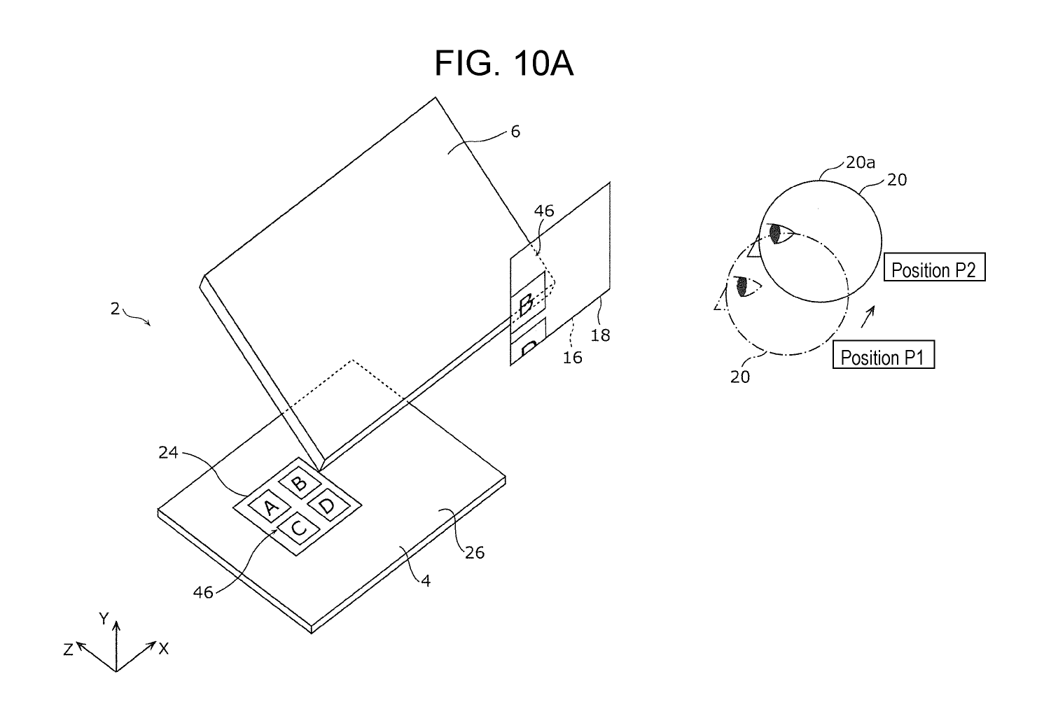

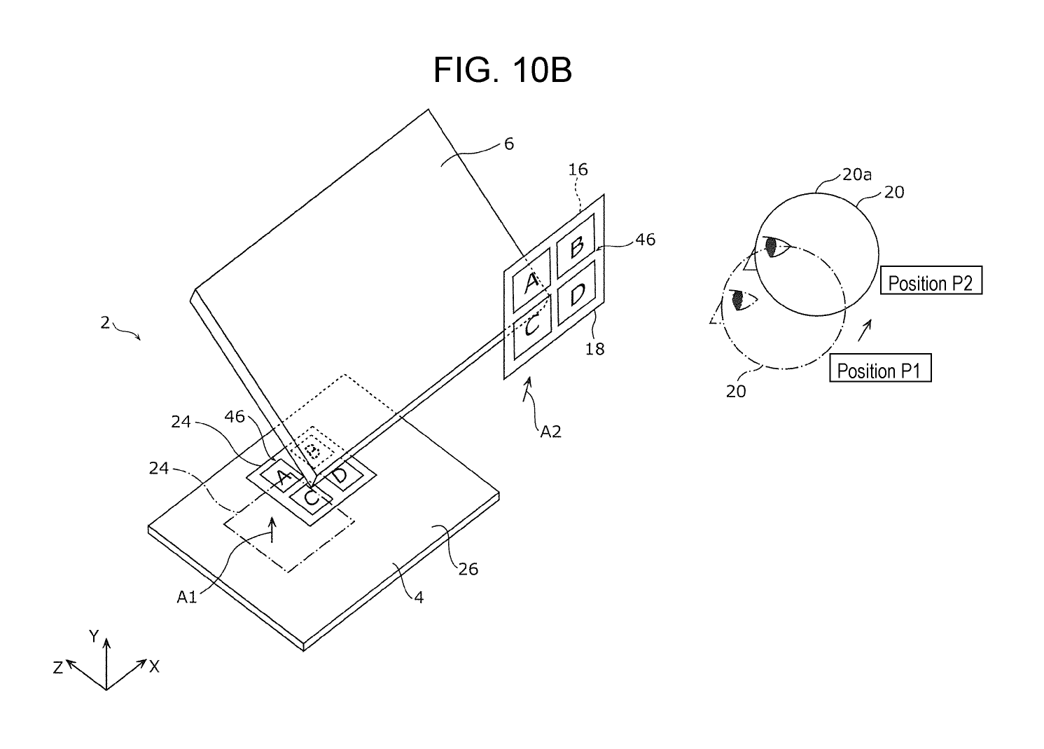

Next, advantageous effects obtained by display device 2 according to the first exemplary embodiment will be described with reference to FIGS. 10A and 10B.

FIG. 10A is a perspective view illustrating a situation in which the posture of user 20 has changed with respect to display device 2. FIG. 10B is a perspective view illustrating a situation in which a display position of aerial image 18 in display region 16 has been adjusted in display device 2.

As illustrated in FIG. 10A, when head 20a of user 20 is positioned at position P1, user 20 is able to visually observe the entire region of operation screen image 46 (aerial image 18) properly. However, as illustrated in FIG. 10A, when head 20a of user 20 has moved from position P1 to position P2 because of a change in the posture of user 20, a partial region of operation screen image 46 is lost when viewed from user 20.

Accordingly, as illustrated in FIG. 10B, display device 2 adjusts at least one of the display position and the size of operation screen image 46 in display surface 26 of display unit 4 so as to follow the movement of head 20a of user 20, when the posture of user 20 changes. At this time, because, as described previously, image 24 and aerial image 18 are in a 1:1 relationship with respect to imaging optical element 6 as the symmetrical axis, at least one of the display position and the size of operation screen image 46 in aerial display region 16 is adjusted. In other words, the shift direction and the scaling factor of operation screen image 46 in display surface 26 of display unit 4 are identical to the shift direction and the scaling factor of operation screen image 46 in aerial display region 16.

As illustrated in FIG. 10B, when head 20a of user 20 has moved from position P1 to position P2 because of a change of the posture of user 20, operation screen image 46 shifts in the direction indicated by arrow A1 within display surface 26 of display unit 4. This causes operation screen image 46 to shift in the direction indicated by arrow A2 within aerial display region 16. As a result, user 20 is able to visually observe the entire region of operation screen image 46 properly.

When head 20a of user 20 has moved in a direction toward display region 16 because of a change of the posture of user 20, the size of image 24 in display surface 26 of display unit 4 can be reduced. This correspondingly reduces the size of operation screen image 46 in display region 16, and therefore, user 20 is able to visually observe the entire region of operation screen image 46 properly.

On the other hand, when head 20a of user 20 has moved in a direction away from display region 16 because of a change of the posture of user 20, the size of image 24 in display surface 26 of display unit 4 can be enlarged. This correspondingly enlarges the size of operation screen image 46 in display region 16. This allows user 20 to be visually observe the entire region of operation screen image 46 easily even when user 20 is at a relatively distant position from display region 16.

### Second Exemplary Embodiment

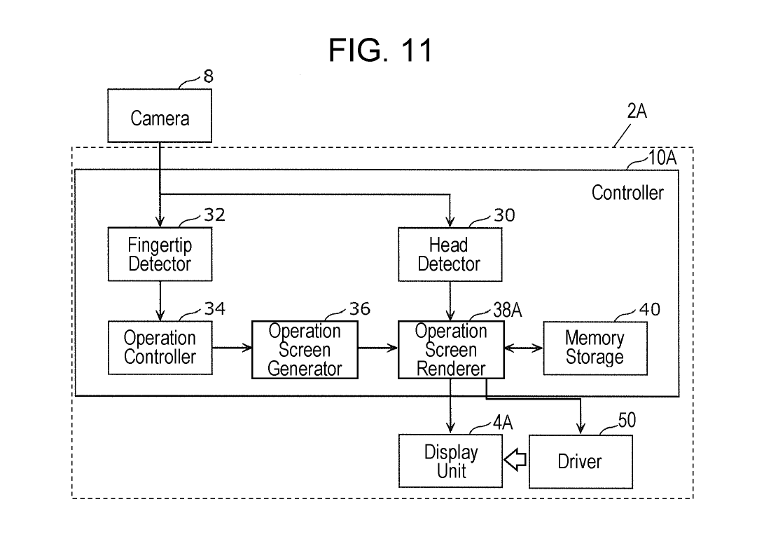

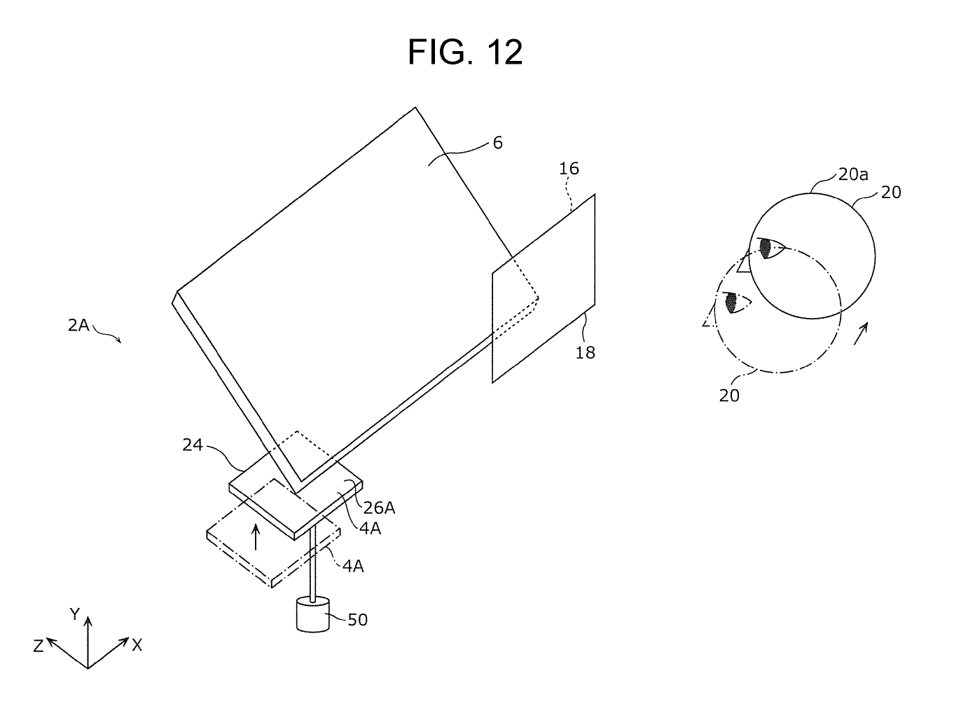

Next, display device 2A according to a second exemplary embodiment will be described with reference to FIGS. 11 and 12. FIG. 11 is a block diagram illustrating the functional configuration of controller 10A of display device 2A. FIG. 12 is a perspective view illustrating the configuration of display device 2A. In the present exemplary embodiment, the same elements as those in the first exemplary embodiment are designated by the same reference signs, and the description thereof will not be repeated.

In addition to the constituent elements of display device 2 according to the first exemplary embodiment, display device 2A further includes driver 50. Driver 50 includes, for example, a motor for shifting display unit 4A with respect to imaging optical element 6. Moreover, controller 10A of display device 2A includes operation screen image renderer 38A, in place of operation screen image renderer 38 shown in FIG. 3. Other than the just-described components, the fundamental configuration is similar to that of display device 2.

In addition, display unit 4A is smaller than display unit 4 of the first exemplary embodiment. This means that the size of image 24 is approximately equal to the size of display surface 26A.

Operation screen image renderer 38A shifts display unit 4A with respect to imaging optical element 6 by driving driver 50 based on the position of head 20a detected by head detector 30. As a result, the position of image 24 is adjusted with respect to imaging optical element 6 in a similar manner to the first exemplary embodiment. Therefore, it is possible to adjust the display position of aerial image 18 in aerial display region 16.

### Modification Examples

Although the display device and the display method according to one or a plurality of aspects of the present disclosure have been described hereinabove based on the foregoing exemplary embodiments, the present disclosure is not limited to these exemplary embodiments. Various embodiments obtained by various modifications made to the exemplary embodiments that are conceivable by those skilled in the art, and various embodiments constructed by any combination of the constituent elements and features of the exemplary embodiments are also to be included within the scope of one or a plurality of aspects of the present disclosure, unless they depart from the spirit of the present disclosure.

Although the foregoing exemplary embodiments have described cases in which display device 2 (2A) is incorporated in automobile 12, but this is merely illustrative. Display device 2 (2A) may be incorporated in, for example, a motorcycle, an aircraft, a train car, or a watercraft. Alternatively, display device 2 (2A) may be incorporated in a variety of equipment, such as automated teller machines (ATM).

Although the foregoing exemplary embodiments have described that display unit 4 (4A) is a liquid crystal display panel, this is merely illustrative. For example, display unit 4 (4A) may be an organic electro-luminescent (EL) panel or the like.

Moreover, although the foregoing exemplary embodiments have described that head detector 30 detects the three-dimensional position of the midpoint between left eye 20c and right eye 20d of user 20 as position 42 of head 20a of user 20, this is merely illustrative. It is also possible that head detector 30 may detect, for example, the three-dimensional position of a central portion of the forehead of user 20, the three-dimensional position of the nose of user 20, or the like, as position 42 of head 20a of user 20.

Each of the constituent elements in the foregoing exemplary embodiments may be composed of dedicated hardware, or may be implemented by executing a software program that is suitable for each of the constituent elements with general-purpose hardware. Each of the constituent elements may also be implemented by reading out a software program recorded in a storage medium, such as a hard disk or a semiconductor memory, and executing the software program by a program execution unit, such as a CPU or a processor.

Note that the present disclosure also encompasses the following.

(1) Each of the foregoing devices may be implemented by a computer system including, for example, a microprocessor, a ROM, a RAM, a hard disk unit, a display unit, a keyboard, and a mouse. The RAM or the hard disk unit stores a computer program. The microprocessor operates in accordance with the computer program, and thereby each of the devices accomplishes its functions. Here, the computer program includes a combination of a plurality of instruction codes indicating instructions to a computer in order to accomplish a certain function.

(2) Some or all of the constituent elements included in the above-described devices may be composed of a single system LSI (large scale integrated circuit). The system LSI is an ultra-multifunctional LSI manufactured by integrating a plurality of components in a single chip, and, specifically, it is a computer system that is configured to include, for example, a microprocessor, a ROM, and a RAM. The ROM stores a computer program. The microprocessor loads the computer program from the ROM into the RAM, and performs arithmetic operations or the like in accordance with the loaded computer program, whereby the system LSI accomplishes its functions.

(3) Some or all of the constituent elements included in the above-described devices may be composed of an IC card or a single module that is attachable to or detachable from the devices. The IC card or the module may be a computer system that includes, for example, a microprocessor, a ROM, and a RAM. The IC card or the module may contain the above-mentioned ultra-multifunctional LSI. The microprocessor operates in accordance with the computer program, whereby the IC card or the module accomplishes its functions. The IC card or the module may be tamper-resistant.

(4) The present disclosure may be implemented by the methods as described above. The present disclosure may also be implemented by a computer program implemented by a computer, or may be implemented by a digital signal including the computer program.

The present disclosure may also be implemented by a computer-readable recording medium in which a computer program or digital signal is stored. Examples of the computer-readable recording medium include a flexible disk, a hard disk, a CD-ROM, a magneto-optical disc (MO), a DVD, a DVD-ROM, a DVD-RAM, a Blu-ray (registered trademark) disc (BD), and a semiconductor memory. The present disclosure may also be implemented by digital signals recorded in such a recording medium.

The present disclosure may also be implemented by a computer program or digital signals transmitted via, for example, data broadcasting or a network such as exemplified by electronic telecommunication network, wireless or wired communication network, and the Internet.

The present disclosure may be implemented by a computer system including a microprocessor and a memory, in which the memory may stores a computer program and the microprocessor may operates in accordance with the computer program.

Furthermore, the present disclosure may also be implemented by another independent computer system by transferring a program or digital signal recorded in a recording medium or by transferring the program or digital signal via a network or the like.

(5) It is also possible that the foregoing exemplary embodiments and the modification examples may be combined with each other.

As described above, a display device according to an aspect of the present disclosure includes a display unit, an imaging optical element, a detector, and an adjustor. The display unit includes a display surface for displaying an image. The imaging optical element includes an element plane. The imaging optical element is configured to cause the image displayed on the display surface to be imaged as an aerial image in an aerial display region positioned plane-symmetrically to the display surface with respect to the element plane. The detector is configured to detect a position of a head of a user existing in front of the display region. The adjustor is configured to adjust a position of the image with respect to the imaging optical element based on a detection result obtained by the detector.

In this aspect, the adjustor adjusts a position of the image with respect to the imaging optical element based on a detection result obtained by the detector. Therefore, it is possible to adjust the position of the aerial image in the aerial display region so as to follow the movement of the head of the user. This enables the user to visually observe the aerial image properly even when the user changes the posture thereof.

For example, the adjustor may also adjust a position of the image in the display surface based on the detection result obtained by the detector.

In this case, the adjustor is able to adjust the position of the image with respect to the imaging optical element with a relatively simple configuration.

For example, the display device may further include a memory storage configured to store a table in which the position of the head of the user is associated with a rendering starting position of the image in the display surface. In this case, the adjustor determines the rendering starting position of the image in the display surface in accordance with the table based on the detection result obtained by the detector, and starts rendering of the image from the determined rendering starting position.

In this case, the adjustor is able to adjust the position of the image in the display surface with a relatively simple configuration.

For example, the adjustor may further adjust a size of the image in the display surface based on the detection result obtained by the detector.

In this case, the user is able to visually observe the aerial image properly even when the head of the user moves toward or away from the aerial display region.

For example, the display device may further include a driver configured to cause the display unit to shift relative to the imaging optical element, and the adjustor may drive the driver based on the detection result obtained by the detector to shift the display unit relative to the imaging optical element.

In this case as well, the adjustor is able to adjust the position of the image with respect to the imaging optical element with a relatively simple configuration.

In a display method according an aspect of the present disclosure, an image is displayed on a display surface of a display unit. The image displayed on the display surface is caused to be imaged as an aerial image in an aerial display region positioned plane-symmetrically to the display surface with respect to an element plane of an imaging optical element. Meanwhile, a position of a head of a user existing in front of the display region is detected. Then, a position of the image with respect to the imaging optical element is adjusted based on the detected position of the head of the user.

According to this method, the position of the image with respect to the imaging optical element is adjusted based on the detected position of the head of the user, and therefore, the position of the aerial image in the aerial display region can be adjusted so as to follow movement of the head of the user. This enables the user to visually observe the aerial image properly even when the posture of the user changes.

Note that these generic or specific aspects may be implemented by a system, a method, an integrated circuit, a computer program, or a computer-readable recording medium such as a CD-ROM. These generic or specific aspects may also be implemented by any combination of systems, methods, integrated circuits, computer programs, or recording media.

As described above, the display device of the present disclosure may be applied to, for example, an aerial display for vehicles.

What is claimed is:

1. A display device comprising:
a display unit including a display surface for displaying an image;
an imaging optical element including an element plane and configured to cause the image displayed on the display surface to be imaged as an aerial image in an aerial display region positioned plane-symmetrically to the display surface with respect to the element plane;
a detector configured to detect a position of a head of a user existing in front of the display region; and
an adjustor configured to adjust a position of the image with respect to the imaging optical element based on a detection result obtained by the detector.

2. The display device according to claim 1, wherein the adjustor adjusts a display position of the image in the display surface based on the detection result obtained by the detector.

3. The display device according to claim 2 further comprising a memory storage configured to store a table in which the position of the head of the user is associated with a rendering starting position of the image in the display surface,
wherein the adjustor determines the rendering starting position of the image in the display surface in accordance with the table based on the detection result obtained by the detector, and starts rendering of the image from the determined rendering starting position.

4. The display device according to claim 1, wherein the adjustor further adjusts a size of the image in the display surface based on the detection result obtained by the detector.

5. The display device according to claim 1 further comprising a driver configured to cause the display unit to shift relative to the imaging optical element,
wherein the adjustor drives the driver based on the detection result obtained by the detector to shift the display unit relative to the imaging optical element.

6. A display method comprising:
displaying an image on a display surface of a display unit;
causing the image displayed on the display surface to be imaged as an aerial image in an aerial display region positioned plane-symmetrically to the display surface with respect to an element plane of an imaging optical element;
detecting a position of a head of a user existing in front of the display region; and
adjusting a position of the image with respect to the imaging optical element based on the detected position of the head of the user.
